(19) United States
(12) Patent Application Publication
(10) Pub. No.: US 2014/0048524 A1
(43) Pub. Date: Feb. 20, 2014

(54) HOT-WIRE CONSUMABLE WITH EMBEDDED ID TAG

(71) Applicant: LINCOLN GLOBAL, INC., City of Industry, CA (US)

(72) Inventors: Elliott ASH, Bay Village, OH (US); William T. MATTHEWS, Chesterland, OH (US)

(73) Assignee: LINCOLN GLOBAL, INC., City of Industry, CA (US)

(21) Appl. No.: 13/794,778

(22) Filed: Mar. 11, 2013

Related U.S. Application Data
(60) Provisional application No. 61/684,849, filed on Aug. 20, 2012.

(51) Int. Cl. B23K 35/00; B23K 9/23

(52) U.S. Cl. CPC B23K 35/00; B23K 9/23
USPC 219/137 R; 219/145.1; 219/136

(57) ABSTRACT

A system and method for using filler wire with embedded information is provided. The filler wire includes a sheath comprising a first filler material and a core that is defined by the sheath. The core includes a second filler material and at least one integrated circuit module. The at least one integrated circuit module includes at least information about the filler wire. In some embodiments, the at least one integrated circuit module is configured for at least one of read operations and write operations that are done using a remote device.

### PRIORITY

The present application claims priority to U.S. Provisional Patent Application No. 61/684,849 filed Aug. 20, 2012, which is incorporated herein by reference in its entirety.

### TECHNICAL FIELD

Certain embodiments relate to a filler wire used in overlaying, welding, and joining applications. More particularly, certain embodiments relate to a system and method that uses a filler wire to deposit at least one identification (ID) tag in a system for any of brazing, cladding, building up, filling, hard-facing overlaying, joining, and welding applications.

### BACKGROUND

Sometimes a manufacturer, construction co., contractor, etc. may wish to keep records related to weld creation, e.g., information about the consumable such as the type, manufacturer, lot no., date of manufacture, etc. and/or other information such as the operator ID; serial number of equipment used, the date weld was created, temperature of weld puddle, cooling rate of weld, etc. In certain cases, such as, e.g., welding on pressure vessels, the operator may be required by law to keep certain information about the weld. While hardcopy and/or on-line records can be kept for each weld, the nexus between the weld and its record can be lost due misplacement of the files, disasters such as fires, passage of time, etc. In addition, it may be time consuming to continually look up each weld's record when inspecting a lot of welds. Accordingly, to facilitate such inspections and to always keep the nexus between the weld and its records, it would be desirable to embed weld information into the weld such that the information can be readily retrieved when desired. For example, in cases where a filler wire is deposited in a welding or surfacing (e.g., cladding, etc.) operation, it may be desirable to embed weld information such as the information discussed above into a component of the filler wire for later retrieval. However, in traditional arc welding or surfacing operations, the presence of the arc creates problems. Any components that can be embedded with information will likely not transfer to the weld intact or in a usable state. This can be due to a number of reasons, including the high temperature of the arc or due to the arc/plasma dynamics present in the arc.

Further limitations and disadvantages of conventional, traditional, and proposed approaches will become apparent to one of skill in the art, through comparison of such approaches with embodiments of the present invention as set forth in the remainder of the present application with reference to the drawings.

### SUMMARY

Embodiments of the present invention comprise a system and method to use at least one filler wire to deposit at least one ID tag in a system for any of brazing, cladding, building up, filling, hard-facing overlaying, welding, and joining applications. The filler wire includes a sheath comprising a first filler material and a core that is defined by the sheath. The core includes a second filler material and at least one integrated circuit module (ID tag). The at least one integrated circuit module includes at least information about the filler wire. In some embodiments, the at least one integrated circuit module is configured for at least one of read operations and write operations that are done using a remote device.

The system includes a high intensity heat source that heats a workpiece to create a molten puddle and a feeder system that feeds the filler wire to the molten puddle. In some embodiments, the system includes a control unit that performs at least one of read operations and write operations on the at least one integrated circuit module. The method includes heating a workpiece to create a molten puddle and feeding the filler wire to the molten puddle. In some embodiments, the method includes performing at least one of read operations and write operations on the at least one integrated circuit module.

The method also includes applying energy from a high intensity energy source to the workpiece to heat the workpiece at least while heating the at least one filler wire. The high intensity energy source may include at least one of a laser device, a plasma arc welding (PAW) device, and a gas tungsten arc welding (GTAW) device, a gas metal arc welding (GMAW) device, a flux cored arc welding (FCAW) device, and a submerged arc welding (SAW) device.

These and other features of the claimed invention, as well as details of illustrated embodiments thereof, will be more fully understood from the following description and drawings.

### BRIEF DESCRIPTION OF THE DRAWINGS

The above and/or other aspects of the invention will be more apparent by describing in detail exemplary embodiments of the invention with reference to the accompanying drawings, in which:

FIG. 1 illustrates a functional schematic block diagram of an exemplary embodiment of a combination filler wire feeder and energy source system for any of brazing, cladding, building up, filling, hard-facing overlaying, welding, and joining applications;

FIGS. 2A-B illustrate an exemplary embodiment of a filler wire that can be used in the system of FIG. 1;

FIGS. 3A-C illustrate exemplary embodiments of ID tag coatings that can be used in the ID tag of FIG. 2;

FIG. 4 illustrates an exemplary embodiment of a multi-filler wire configuration that can be used in the system of FIG. 1; and

FIG. 5 illustrates an exemplary embodiment of a weld or cladding bead having ID tags in a surface thereof.

### DETAILED DESCRIPTION

Exemplary embodiments of the invention will now be described below by reference to the attached Figures. The described exemplary embodiments are intended to assist in the understanding of the invention, and are not intended to limit the scope of the invention in any way. Although much of the following discussions will reference “welding” operations and systems, embodiments of the present invention are not just limited to joining operations, but can similarly be used for cladding, brazing, overlaying, etc.—type operations. Like reference numerals refer to like elements throughout.

As indicated above, it would be desirable to embed information concerning the weld creation into the weld for later retrieval. Because welding/joining operations typically involve a filler metal that is combined with at least some of the workpiece metal to form the weld joint, it would desirable to embed the information in the filler material, e.g., as a component of the filler material. In this way, some or all of the records for weld creation can stay with the weld, rather than having to be filed in a remote location. However, because traditional methods can use an arc to transfer the filler material, any materials containing this information may get consumed, damaged or altered in the arc, rather than being deposited intact in the weld puddle. According, unlike most welding processes, the present invention does not use an arc to heat, melt and transfer the filler materials to the weld joint or cladding layer. As described below, exemplary embodiments of the present invention can deposit information containing materials into the weld joint, which provides significant advantages over existing welding technologies.

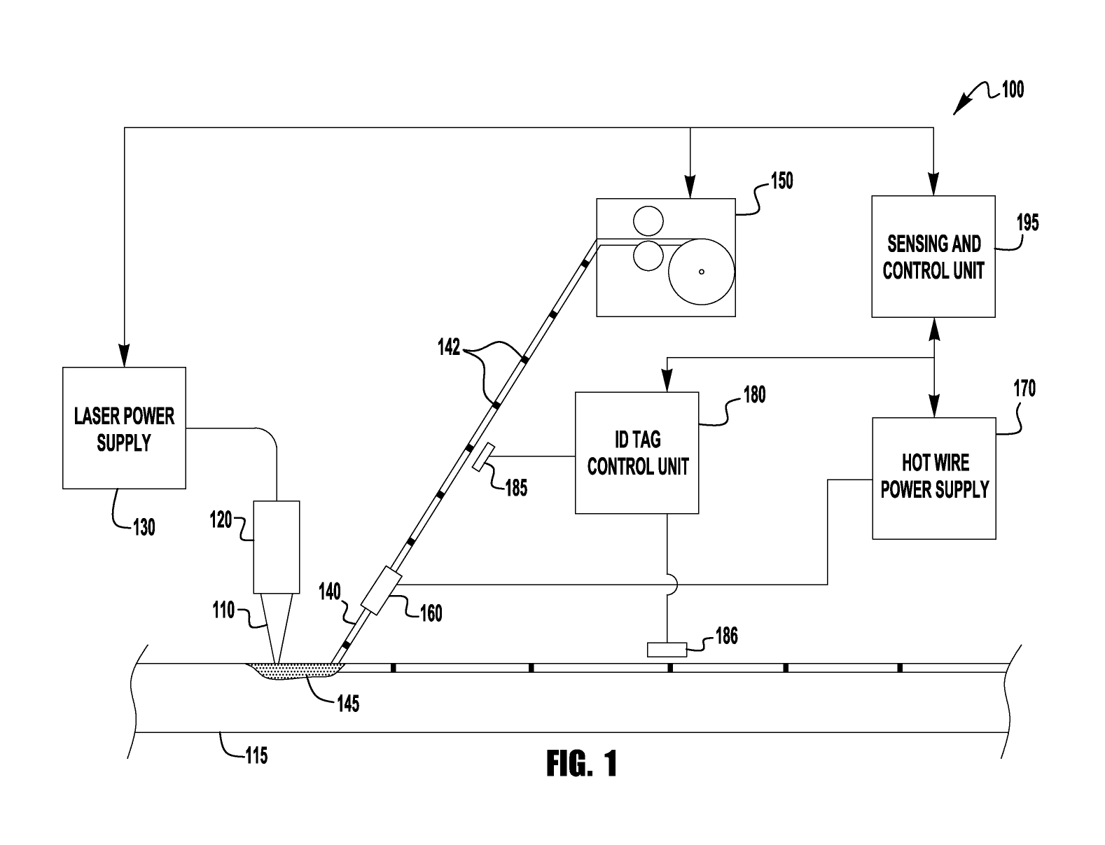

FIG. 1 illustrates a functional schematic block diagram of an exemplary embodiment of a combination filler wire feeder and energy source system 100 for performing any of brazing, cladding, building up, filling, hard-facing overlaying, and joining/welding applications. The system 100 includes a high energy heat source 120/130 capable of heating the workpiece 115 to form a weld puddle 145. The high energy heat source can be a laser subsystem 130/120 that includes a laser device 120 and a laser power supply 130 operatively connected to each other. The laser 120 is capable of focusing a laser beam 110 onto the workpiece 115 and the power supply 130 provides the power to operate the laser device 120. The laser subsystem 130/120 can be any type of high energy laser source, including but not limited to carbon dioxide, Nd:YAG, Yb-disk, YB-fiber, fiber delivered, or direct diode laser systems. Further, even white light or quartz laser type systems can be used if they have sufficient energy. For example, a high intensity energy source can provide at least 500 W/cm².

The following specification will repeatedly refer to the laser subsystem 130/120, beam 110 and laser power supply 130, however, it should be understood that this reference is exemplary as any high intensity energy source may be used. For example, other embodiments of the high energy heat source may include at least one of an electron beam, a plasma arc welding subsystem, a gas tungsten arc welding subsystem, a gas metal arc welding subsystem, a flux cored arc welding subsystem, and a submerged arc welding subsystem.

It should be noted that the high intensity energy sources, such as the laser device 120 discussed herein, should be of a type having sufficient power to provide the necessary energy density for the desired welding operation. That is, the laser device 120 should have a capability to modify the energy from the laser power supply (or other source) to create and maintain a stable weld puddle throughout the welding process, and also reach the desired weld penetration. For example, for some applications, lasers should have the ability to “keyhole” into the workpieces being welded. This means that the laser should have sufficient power density to penetrate (partially or fully) into the workpiece, while maintaining that level of penetration as the laser travels along the workpiece. Exemplary lasers should have power capabilities in the range of 1 to 20 kW, and may have a power capability in the range of 5 to 20 kW. In other exemplary embodiments, the power density can be in the range of 10⁵ to 10⁸ watts/cm². Higher power lasers can be utilized, but can become very costly.

The system 100 also includes a hot filler wire feeder subsystem capable of providing at least one filler wire 140 to make contact with the workpiece 115 in the vicinity of the laser beam 110. Of course, it is understood that by reference to the workpiece 115 herein, the molten puddle, i.e., weld puddle 145, is considered part of the workpiece 115, thus reference to contact with the workpiece 115 includes contact with the puddle 145. The hot filler wire feeder subsystem includes a filler wire feeder 150, a contact tube 160, and a hot wire power supply 170. In accordance with an embodiment of the present invention, the hot wire welding power supply 170 is a direct current (DC) power supply (that can be pulsed, for example), although alternating current (AC) or other types of power supplies are possible as well. The wire 140 is fed from the filler wire feeder 150 through the contact tube 160 toward the workpiece 115 and extends beyond the tube 160. During operation, the extension portion of the filler wire 140 is resistance-heated by an electrical current from the hot wire welding power supply 170, which is operatively connected between the contact tube 160 and the workpiece 115. Prior to its entry into the weld puddle 145 on the workpiece 115, the extension portion of the wire 140 may be resistance-heated such that the extension portion approaches or reaches the melting point before contacting the weld puddle 145 on the workpiece 115. Because the filler wire 140 is heated to at or near its melting point, its presence in the weld puddle 145 will not appreciably cool or solidify the puddle 145 and the wire 140 is quickly consumed into the weld puddle 145. The laser beam 110 (or other energy source) serves to melt some of the base metal of the workpiece 115 to form the weld puddle 145 and complete the melting of the wire 140 onto the workpiece 115. However, the power supply 170 provides the energy needed to resistance-heat the filler wire 140 to or near a molten temperature.

The system 100 also includes sensing and control unit 195. The sensing and control unit 195 can be operatively connected to the power supply 170, the wire feeder 150, the laser power supply 130, and/or ID tag control unit 180 (discussed further below) to control the welding process in system 100. U.S. patent application Ser. No. 13/212,025, titled “Method And System To Start And Use Combination Filler Wire Feed And High Intensity Energy Source For Welding” is incorporated by reference in its entirety and provides exemplary methods and systems of operating the system 100.

As indicated above, the present invention melts the filler wire 140 into the weld puddle 145 rather than using a welding arc to heat, melt and transfer the filler wire 140 into the weld puddle 145. Because no arc is used to transfer of the filler wire 140 in the process described herein, the filler wire can include materials that normally would be consumed in, interact with, or damaged by the arc in such a manner as to not exist or be rendered inoperable in the puddle following solidification. For example, materials such as integrated circuits can be transferred in the filler materials. These integrated circuits, referred herein as “ID tags,” can be configured to include information related to weld creation as discussed above, and can be deposited into the weld or cladding via tag modules 142, which will be discussed further below. “ID tag” as used herein is intended to include any type of integrated circuit, RFID device, or any other type of device that can store data which can be interrogated at a later time to retrieve the data.

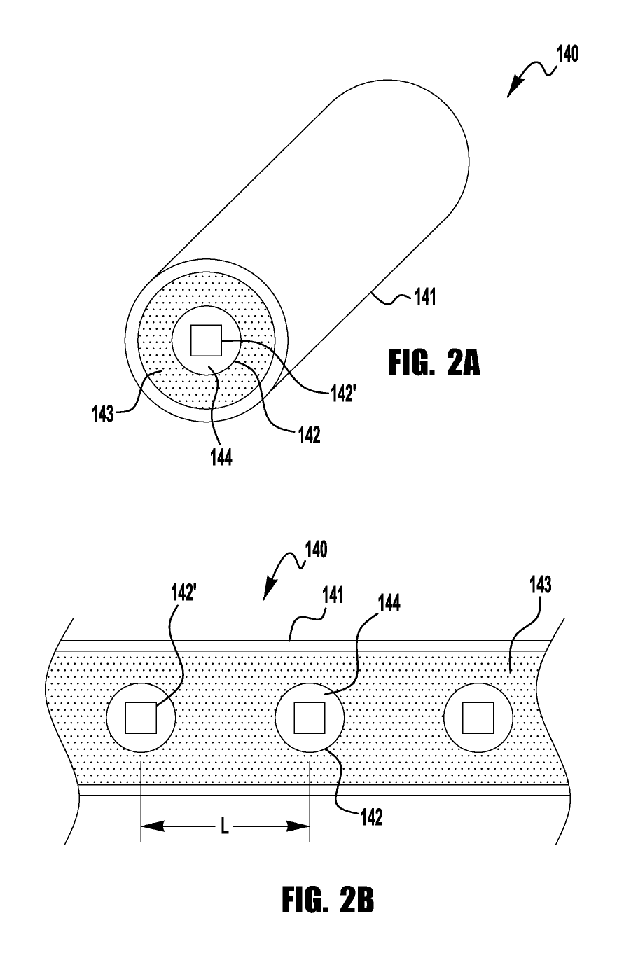

In an exemplary embodiment, as illustrated in FIGS. 2A and 2B, the filler wire 140 is composed of a sheath 141 and a core 143. The sheath 141 can be made of any filler material that is appropriate for the process, weld, cladding, etc. Further, the core 143 can be made up of a number of different compositions depending in the desired process parameters. For example, the core can be a solid material, can be a flux material, can be metallic powder, etc., without departing from the spirit or scope of the present invention. Thus, the core 143 can be made of a solid material which can have a composition which is similar to, or different from, the sheath 141. Alternatively, the core 143 can be made of a flux, powder, etc. as needed for the process. As shown, the tag modules 142 are embedded in the core 143 of the wire 140 so that they can be delivered to the puddle 145 during the process. In exemplary embodiments, the tag modules 142 can be comprised of an ID tag 142′ and a tag coating 144. The tag coating 144 can be any type of material which is capable of protecting the ID tag 142′ from the molten puddle 145 or the process so that it retains its integrity. Such materials can include, but are not limited to nickel, ceramic, etc. In yet a further embodiment, the wire 140 can be solid with tag modules 142 embedded therein.

The size of the tag modules 142 are such that they can be deposited into the puddle 145 and not adversely interfere with the completed joint, surface etc. For example, the tag modules can have a maximum outer diameter size in the range of 0.7 mm to 1.5 mm to allow them to fit into a consumable. The length of tag module is not so limited. Of course, the utilized size must take into account the resultant utilization of the wire 140 and the geometry of the weld bead, cladding layer, etc. Furthermore, embodiments of the present invention are not limited to the outer shaping of the coating 144. Thus, in some embodiments the tag module 142 can have a spherical, elliptical or oval shape. However, it should be noted that is some applications the tag module 142 is to have a shape that avoids the use of sharp corners which can cause stress concentrations in a resultant weld bead or joint.

In some embodiments of the invention, the ID tags 142 are distributed in the wire 140 at periodic distances L. For example, one or more tag modules 142 may be deposited into the wire 140 every 6 to 36 inches. Of course, the modules 142 may be distributed at any desired frequency or even randomly as long as the application requirements are met and the inclusion of the modules 142 does not substantially affect the integrity of the weld, coating, etc.

In exemplary embodiments, the ID tags 142′ include information that relates to the consumable such as the type of wire, manufacturer, lot or production no., date of production, etc. Any other desired information can be stored on the tags 142′. The ID tags 142′ may also be configured to include information concerning the weld creation such as the operator ID, the date/time of the weld, the welding process (e.g., GMAW, GTAW, PAW, etc.), the temperature of the weld puddle, weld cooling rate, etc. In some embodiments, the ID tags 142′ are passive in that they do not transmit the information until scanned by a reading device. In other embodiments, the ID tags 142′ are active and transmit the information, e.g., periodically such as once every minute. The ID tags 142′ may also include sensors that, for example, monitor the temperature of the weld, etc. In some exemplary embodiments of the present invention, the retrieval of information from the ID tags 142′ includes nondestructive methods such as wired or wireless communications. In some exemplary embodiments, the ID tags 142′ are radio frequency ID (“RFID”) tags. The construction of ID tags such as RFID tags are well known in the art and will not be further discussed.

When configuring the welding system to use wire 140 with ID tags 142′, the temperature rating of the ID tags 142′ may be important. This is because, depending on the welding operation, type of materials being welded, type of consumable wire 140, etc., the temperature of wire 140 after contact tube 160 and/or the weld puddle 145 may be above the rated temperature of ID tag 142′ for read/write operations to function. That is, devices will not be able to read from or write to the ID tags 142′ until the temperature of the ID tags 142′ drops below the rated temperature. Accordingly, in such cases, any read/write operation must occur prior to the ID tag's insertion in to weld puddle 145 and after the weld cools sufficiently. For example, the welding system 100 can be configured to write the desired information into ID tags 142′ immediately prior to their insertion into weld puddle 145 and read it at a point downstream of welding operations after the weld has cooled to below the rated temperature of the ID tags 142′.

As illustrated in FIG. 1, an ID tag control unit 180 can be operatively connected to ID tag writer 185 and ID tag reader 186 to respectively write information to or read information from ID tags 142′ in the modules 142. Of course, the read/write functions may be incorporated into a singe device if desired. The ID tag writer 185 can transmit (i.e., write) weld creation information such as date/time of weld, operator ID, type of welding process, type of filler wire, manufacturer of filer wire, etc. to ID tag 142′. If the temperature of the weld puddle 145 will be above the rated temperature of the ID tags 142′, the welding system 100 can be set up such that ID tag writer 185 writes the desired information prior to the ID tag 142′ being inserted in the weld puddle 145. Of course, the ID tag 142′ may be pre-configured with some of the desired information such as type of wire and manufacturer at the time the wire 140 was manufactured or shipped. An ID tag reader 186 may be used to read the information from ID tag 142′. For example, ID tag control unit 180 may verify that the weld information was correctly written by ID tag writer 185 by reading the information from the ID tags 142′ at a point downstream of the welding operation. Once written, the information in ID tags 142′ may be retrieved at any time. For example, inspection personnel can use portable readers (not shown) to access the information written to the ID tags 142′ at any time, even years later. In some embodiments, the ID tags 142′ include a sensor (not shown) that can measure and store parameters such as the maximum temperature and the cool down rate—to name just a few parameters.

In some cases, the temperature of wire 140 and/or weld puddle 145 may be high enough to damage the ID tags 142′. For example, the heat of an arc can be as high as 8,000° F., and the melting temperature of the filler wire 140, which will vary depending on the size and chemistry of the wire 140, can exceed 1,500° F. In such cases, the ID tags 142′ may need to be protected from the heat of the wire 140 and/or weld puddle 145. This was explained briefly above with respect to the coating 144.

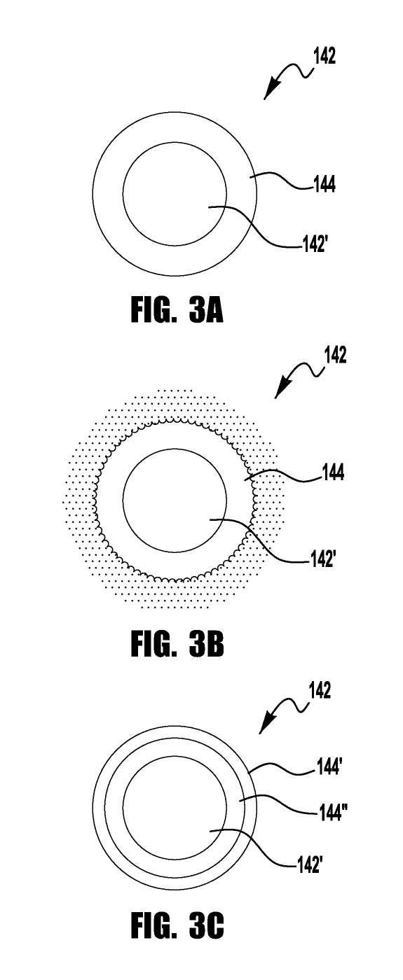

FIGS. 3A to 3C depict exemplary embodiment of modules 142 within the scope of the present invention. As shown in FIG. 3A, which depicts a similar module to FIG. 2A, the module 142 is constructed such that a coating 144 surrounds the ID tag 142′. In some embodiments, the coating 144 is an insulating coating which protects the tag 142′ from any high heat exposure. For example, the coating 144 can be a ceramic coating. That is, the coating 144 can be any composition that resists the transfer of heat such that the puddle 145 cools and solidifies before the tag 142′ is destroyed by the heat. In the embodiment shown, there is a single coating 144, but other exemplary embodiments are not limited to this, as the coating 144 can be made up of a plurality of different layers having different thermal protective properties to optimize protection of the tag 142′. In other embodiments (FIG. 3B), the outer portions of the coating 144 may be designed to melt and/or ablate in order to protect the tag 142′. In such cases, the coating 144 may interact with the molten components in the puddle 145 (filler wire and/or workpiece). In such embodiments, the coating 144 melts away from the module 142 in an effort to absorb and/or dissipate heat from the tag 142′. In such embodiments, the coating can be a nickel or other metallic material that will melt, but still provide thermal protection to the tag 142′. In still other embodiments (FIG. 3C), the tag 142′ is protected by plurality of layers having different thermal properties, such as melting temperatures. For example, the module can have a first coating layer 144″ that insulates and a second coating layer 144′ that melts and/or ablates. For example, the first layer 144″ can be made from a ceramic material, while the second layer 144′ is made from a metal that will at least partially melt in the puddle 145. In the above embodiments, the type and thickness of the coatings 144, 144′ and/or 144″ can depend on the process being utilized, the temperature rating of the ID tag 142′, the maximum temperatures of the weld puddle 145, the wire 140, and the expected cooling rate of puddle 145. Various manufacturing methods can be used to coat the particles, including using vapor deposition, or other similar coating methods.

As discussed above, the temperature of the wire 140 and/or the puddle 145 can be an important operational parameter depending on the temperature rating of the ID tag 142′ being deposited. In addition, it may be desirable for the ID tag 142′ to include the temperature of the filler wire 140 and/or the puddle 145 for future reference. Accordingly, in yet another exemplary embodiment of the present invention, the system 100 can include thermal sensors (not shown) that monitor the temperature of filler wire 140 and of puddle 145. The temperature can then be used to control the heating of wire 140 and of the puddle 145 by laser beam 110 to ensure the ID tags 142′ are not damaged while maintaining weld quality. For example, as each module 142 is to enter the puddle the system 100 can be controlled such that the heat input is temporarily reduced by either reducing or turning off the laser briefly. Alternatively, or additionally, any heating methodology used to heat the wire 140 (such as resistance heating) can be reduced at the point that a module 142 is to enter the puddle 145. These, and other temperature measurements, can be written to ID tags 142′ by ID tag control unit 180. U.S. patent application Ser. No. 13/212,025, titled “Method And System To Start And Use Combination Filler Wire Feed And High Intensity Energy Source For Welding” is incorporated by reference in its entirety, provides exemplary embodiments on how sensors can be incorporated into sensing and control unit 195 for operating system 100.

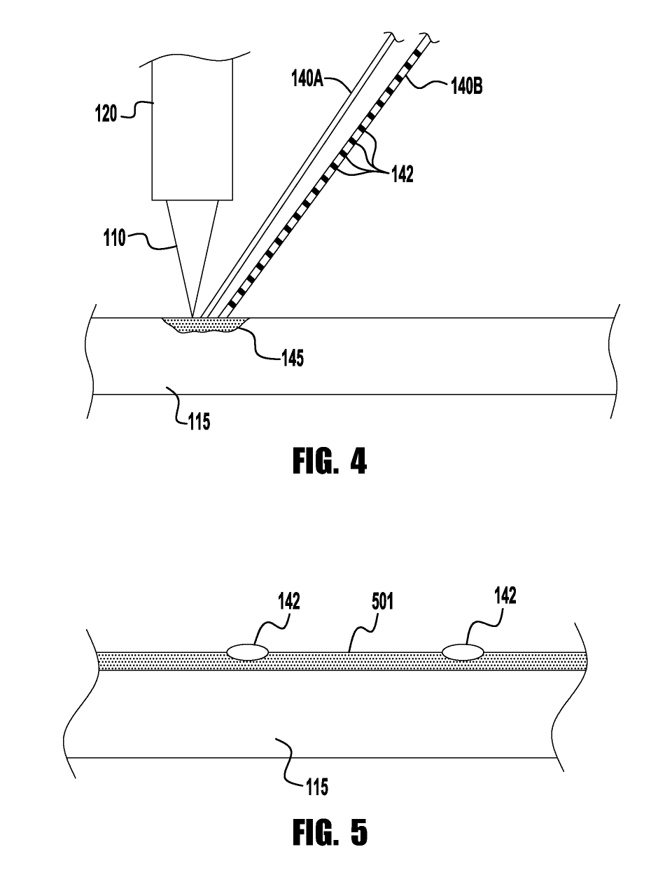

Of course, the ID tags 142′ and the filler material need not be included in the same wire or consumable. Because, in some embodiments, an arc is not used to transfer the filler wire to the puddle 145, the feeder subsystem can be configured to simultaneously provide more than one wire to the puddle at the same time, in accordance with certain other embodiments of the present invention. For example, in some exemplary multi-wire embodiments one of the wires (for example the leading wire) can deposit the matrix of the weld joint while any additional wires adds the ID tags 142′ as described herein. That is, as shown in FIG. 4, a first wire 140A may be used to add structure to the workpiece and a second wire 140B may be used for depositing the modules 142 to the workpiece 115. In this way, a standard filler wire 140A can be used for most welding operations and filler wire 140B is only fed into the puddle 145 when weld information needs to be inserted. Because the filler wire 140B is designed for depositing the modules 142, any heating (if needed) of filler wire 140B can be done independently of wire 140A to ensure that the wire 140B in under the rated temperature of ID tags 142′. Accordingly, in some embodiments, the second wire 140B is not heated or is heated to a temperature that is below the temperature rating of ID tags 142′ in order to minimize the risk of heat damage to the tags 142′. The second wire 140B can then inserted into a trailing edge of puddle 145 such that the second wire 140B will fully melt but will also quickly solidify and cool the puddle 145. In this way, the amount of heat seen by the ID tag 142′ is minimized. In some embodiments, the wire feed speed of the second wire 140B is different from the first wire 140A. In some embodiments, the wire feed speed of the second wire 140B is less than that of the first wire 140A such that the ID tags 142′ can be closely spaced in second wire 140B to, for example, minimize manufacturing costs. In other embodiments, the wire feed speed of the second wire 140B is more than that of the first wire 140A or the same as the first wire 140A.

The density of the material used for the coatings 144 of the ID tags 142′ may vary depending on the application and whether it is desirable to have the ID tag 142′ near the top of the weld joint or at the bottom. For example, in some embodiments, devices may not be able to read from or write to the ID tags 142′ if they are deposited too deep in the weld. In such cases, it may be desirable to have a module 142 that is less dense than the surrounding filler material so that the module 142 goes to the top of the weld joint as it cools. In other application such as, for example, out-of-position welding, it may be desirable to have a module 142 that is denser than the surrounding filler material. Of course, in some cases it may be desirable for modules 142 to have the same density as the surrounding filler material. To achieve the desired density the density of the coating 144 can be utilized to achieve the desired density for the entire module 142. It is noted that although the above embodiments show a typical weld joint, embodiments of the present invention are not limited in this regard as the wires can also be used for cladding/surfacing operations, and can be used in other weld joint types. These figures are intended to be exemplary.

In other exemplary embodiments, similar to FIG. 4, the modules 142 are deposited onto or into the puddle 145 via a methodology not including the utilization of a wire 140B as a delivery system. For example, some exemplary embodiments the modules 142 can be dropped onto the puddle 145 as the operation is processing from a device that places the modules in the appropriate position of the weld puddle before the puddle solidifies. This can be done in operations where it is not desirable to have the modules 142 completely submerged within the puddle 145, but rather embedded on a surface thereof. For example, as shown in FIG. 5, embodiments of the present invention, can use a placement mechanism (not shown) to place the modules 142 on a surface of the weld or cladding bead 501 such that at least some of the modules 142 is exposed. In such embodiments, the modules 142 can be deposited downstream of the joining/cladding operation but prior to the bead 501 solidifying such that the modules are at least partially embedded and secured into the bead 501, but they are at least somewhat exposed to allow reading and recording of data to be easier. Further, such embodiments could minimize compromising the structural integrity of the bead 501 or weld joint by completely submerging the modules within the bead 501. Further, such embodiments can allow the placement of the modules 142 to easily vary during the operation such that the modules can be placed as desired. For example, rather than placing the modules 142 every fixed distance (corresponding to distance L in the wire 140) the modules can be placed at the beginning and end of an operation, and at various points in between an operation. Further, placement can be achieved at locations which are not structurally critical.

In FIG. 1, the laser power supply 130, hot wire power supply 170, wire feeder 150, ID tag control unit 180, and sensing and control unit 195 are shown separately for clarity. However, in embodiments of the invention these components can be made integral into a single welding system. Aspects of the present invention do not require the individually discussed components above to be maintained as separately physical units or stand alone structures.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

1. A filler wire with embedded information, said filler wire comprising:
a sheath comprising a first filler material; and
a core defined by said sheath and comprising a second filler material and at least one integrated circuit module,
wherein said at least one integrated circuit module comprises at least information about said filler wire.

2. The filler wire of claim 1, wherein said at least one integrated circuit module is configured for at least one of read operations and write operations that are done using a remote device.

3. The filler wire of claim 2, wherein said at least one integrated circuit module is an RFID device.

4. The filler wire of claim 1, wherein said filler wire information comprises at least one of filler wire type, manufacturer, production number, and date of manufacture.

5. The filler wire of claim 1, wherein said integrated circuit is configured to store information about a process in which said filler wire is used,
wherein said process information comprises at least one of type of said process, operator ID, date of said process, time of said process, temperature of molten puddle, and rate of cooling of said molten puddle.

6. The filler wire of claim 1, wherein said at least one integrated circuit module has an outer shape that is one of spherical, elliptical and oval.

7. The filler wire of claim 1, wherein said at least one integrated circuit module comprises an insulating coating.

8. The filler wire of claim 6, wherein said insulating coating comprises ceramic.

9. The filler wire of claim 1, wherein said at least one integrated circuit module comprises a protective coating that melts or abalates to protect said at least one integrated circuit module.

10. The filler wire of claim 1, wherein said protective coating comprises nickel.

11. A system for using a filler wire with embedded information, said system comprising:
a high intensity heat source that heats a workpiece to create a molten puddle; and
a feeder system that feeds said filler wire to said molten puddle,
wherein said filler wire comprises,
a sheath comprising a first filler material; and
a core defined by said sheath and comprising a second filler material and at least one integrated circuit module,
wherein said at least one integrated circuit module comprises at least information about said filler wire.

12. The system of claim 11, further comprising:
a control unit that performs at least one of read operations and write operations on said at least one integrated circuit module.

13. The system of claim 12, wherein said at least one integrated circuit module is an RFID device.

14. The system of claim 11, wherein said filler wire information comprises at least one of filler wire type, manufacturer, production number, and date of manufacture.

15. The system of claim 11, wherein said integrated circuit is configured to store information about a process in which said filler wire is used,
wherein said process information comprises at least one of type of said process, operator ID, date of said process, time of said process, temperature of said molten puddle, and rate of cooling of said molten puddle.

16. A method for using filler wire with embedded information, said method comprising:
heating a workpiece to create a molten puddle; and
feeding said filler wire to said molten puddle,
wherein said filler wire comprises,
a sheath comprising a first filler material; and
a core defined by said sheath and comprising a second filler material and at least one integrated circuit module,
wherein said at least one integrated circuit module comprises at least information about said filler wire.

17. The method of claim 16, further comprising:
performing at least one of read operations and write operations on said at least one integrated circuit module.

18. The method of claim 17, wherein said at least one integrated circuit module is an RFID device.

19. The method of claim 16, wherein said filler wire information comprises at least one of filler wire type, manufacturer, production number, and date of manufacture.

20. The method of claim 16, further comprising:
storing information about a process in which said filler wire is used,
wherein said process information comprises at least one of type of said process, operator ID, date of said process, time of said process, temperature of said molten puddle, and rate of cooling of said molten puddle.
